(19) United States
(12) Patent Application Publication
(10) Pub. No.: US 2025/0259611 A1
(43) Pub. Date: Aug. 14, 2025

(54) GENERATIVE ADDITION OF MUSICAL INSTRUMENT TONES TO SONGS

(71) Applicant: Infosys Limited, Bangalore (IN)

(72) Inventors: Laurel Thejas Souza, Bengaluru (IN); Vikram Nagaraja Rao, Bengaluru (IN)

(73) Assignee: Infosys Limited, Bangalore (IN)

(21) Appl. No.: 19/094,282

(22) Filed: Mar. 28, 2025

(30) Foreign Application Priority Data
Feb. 13, 2025 (IN) 202541012395

(51) Int. Cl. G10H 1/40

(52) U.S. Cl. CPC G10H 1/40; G10H 2210/005

(57) ABSTRACT

Generative filling of musical instrument tones to songs is provided. For a vocal track, a genre and musical instruments to be added to the vocal track are determined. Using an audio synthesis model, an audio tone is generated for each musical instrument in conformity with the genre. Further, each audio tone is converted into a spectrogram, which when processed based on temporal dependencies, generates a refined temporal sequence for the audio tone. Based on the refined temporal sequence of each audio tone, an audio waveform is generated. A simple additive mixing operation is executed on the vocal track and the audio waveforms generated for the musical instruments to generate an audio track (e.g., a new song).

### FIELD OF THE DISCLOSURE

Various embodiments of the present disclosure relate generally to audio synthesis. More specifically, various embodiments of the present disclosure relate to generative addition of musical instrument tones to songs.

### BACKGROUND

Music has long served as a universal medium for expression and entertainment, with songs playing a significant role in cultural, social, and personal experiences throughout history. A song typically combines vocals with musical instrument tones, each contributing unique elements that define its character. These elements are further enriched by subsidiary attributes such as pitch, genre, and other stylistic nuances. Typically, a song is recorded in a recording studio using various recording devices. In such scenarios, if a new musical instrument tone needs to be incorporated after the initial recording, the entire song often must be re-recorded with the added tone. Such addition of the musical instrument tone is both labor-intensive and time-consuming. Additionally, the human-driven nature renders this approach error-prone.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for generative addition of musical instrument tones to songs are provided substantially as shown in, and described in connection with, at least one of the figures.

In an embodiment of the present disclosure, a system including processing circuitry is disclosed. The processing circuitry may be configured to determine, for a vocal track, at least one of a genre and a set of musical instruments to be added to the vocal track. The processing circuitry may be configured to generate, in conformity with the genre, an audio tone for each musical instrument of the set of musical instruments. Further, the processing circuitry may be configured to obtain a refined temporal sequence for the audio tone based on one or more temporal dependencies associated with the audio tone and generate an audio waveform using the refined temporal sequence. The processing circuitry may be further configured to generate, based on the vocal track and the audio waveform generated for each musical instrument of the set of musical instruments, an audio track.

In some embodiments, the processing circuitry generates the audio tone for each musical instrument of the set of musical instruments in conformity with the genre using an audio synthesis model.

In some embodiments, the audio synthesis model corresponds to a combination of WaveNet and Generative Adversarial Network (GAN).

In some embodiments, the audio synthesis model is trained using an audio dataset including a plurality of audio tracks. The training of the audio synthesis model includes extraction of a set of audio features for each audio track of the plurality of audio tracks, segmentation of each audio track into one or more musical instrument tracks based on the corresponding set of audio features, and identification of one or more instrument tones for the one or more musical instrument tracks, respectively. The training of the audio synthesis model further includes determination of a reference genre and one or more musical instruments of each audio track based on the set of audio features, the one or more musical instrument tracks, and the one or more instrument tones. Further, the training of the audio synthesis model includes generation of one or more audio tones for the one or more musical instruments, respectively, in conformity with the reference genre. The one or more audio tones are generated based on the identified one or more instrument tones using the audio synthesis model. The audio synthesis model is iteratively trained based on the one or more instrument tones identified for each remaining audio track of the plurality of audio tracks.

In some embodiments, the processing circuitry is further configured to generate, for each musical instrument of the set of musical instruments, a spectrogram that is a time-frequency representation of the audio tone generated for the corresponding musical instrument, and process the spectrogram based on the one or more temporal dependencies to obtain the refined temporal sequence for the audio tone.

In some embodiments, the audio tone generated for each musical instrument of the set of musical instruments is a time-domain signal. The processing circuitry generates the spectrogram based on a Short-Time Fourier Transform (STFT) operation on the audio tone.

In some embodiments, the processing circuitry is further configured to generate the spectrogram by executing the STFT operation on the audio tone to generate a complex spectrogram that includes amplitude information and phase information, extract an amplitude spectrogram from the complex spectrogram based on the amplitude information, and transform the amplitude spectrogram into a time-frequency domain.

In some embodiments, the processing circuitry generates the audio waveform by executing an Inverse Short-Time Fourier Transform (ISTFT) operation on the refined temporal sequence. The audio waveform is a time-domain audio signal.

In some embodiments, the processing circuitry obtains the refined temporal sequence using a bidirectional sequence model.

In some embodiments, the bidirectional sequence model corresponds to a Bidirectional Long Short-Term Memory (Bi-LSTM) model.

In some embodiments, to generate the audio track, the processing circuitry is further configured to execute a Simple Additive Mixing (SMA) operation on the vocal track and the audio waveform generated for each musical instrument of the set of musical instruments.

In some embodiments, the processing circuitry is further configured to receive an input song and a user input defining the genre and the set of musical instruments to be added to the vocal track.

In some embodiments, the processing circuitry is further configured to process the input song to determine the vocal track and at least one musical instrument tone present in the input song and separate the vocal track and the at least one musical instrument tone.

In some embodiments, the at least one musical instrument tone is one of (i) retained in the audio track or (ii) absent in the audio track.

In some embodiments, the user input further defines a time interval within the input song where the set of musical instruments is to be added, and the processing circuitry generates the audio track such that the audio waveform of each of the set of musical instruments is added to the vocal track in synchronization with the defined time interval.

In another embodiment of the present disclosure, a system is disclosed. The system comprises a processing circuitry. The processing circuitry is configured to extract, from an audio dataset comprising a plurality of audio tracks, a first set of audio features for each audio track of the plurality of audio tracks. The processing circuitry is further configured to segment each audio track into one or more musical instrument tracks based on the corresponding first set of audio features, and identify one or more instrument tones for the one or more musical instrument tracks, respectively. Further, the processing circuitry is configured to determine a genre and one or more musical instruments of each audio track based on the first set of audio features, the one or more musical instrument tracks, and the one or more instrument tones. Using an audio synthesis model, the processing circuitry is further configured to generate one or more audio tones for the one or more musical instruments, respectively, in conformity with the genre based on the identified one or more instrument tones. The audio synthesis model is iteratively trained based on the one or more instrument tones identified for each remaining audio track of the plurality of audio tracks. The trained audio synthesis model facilitates musical instrument tone synthesis for a vocal track.

In some embodiments, the audio dataset further comprises metadata associated with each audio track of the plurality of audio tracks. The metadata includes at least one of the genre, a title, artist information, an album, release information, a duration, a time stamp, producer information, and a set of musical instruments included in the corresponding audio track. The audio synthesis model is trained further based on the metadata associated with each audio track of the plurality of audio tracks.

In some embodiments, the first set of audio features comprises at least one of rhythm, pitch, beat, and tone of each audio track of the plurality of audio tracks.

In some embodiments, the processing circuitry is further configured to extract a second set of features for each audio track of the plurality of audio tracks. The second set of features comprises at least one of Mel-Frequency Cepstral Coefficients (MFCC), rhythmic patterns, pitch contours, harmonic structures, spectral centroid, and spectral bandwidth. The one or more instrument tones for the one or more musical instrument tracks, respectively, are identified based on the second set of features.

In some embodiments, the processing circuitry identifies the one or more instrument tones for the one or more musical instrument tracks, respectively, using a Support Vector Machine (SVM) classifier model.

In some embodiments, the processing circuitry is further configured to validate compatibility between the genre and each of the one or more musical instruments. An audio tone, of the one or more audio tones, for each of the one or more musical instruments is generated based on the successful validation of the compatibility between the genre and the corresponding musical instrument.

In some embodiments, the audio synthesis model corresponds to a combination of WaveNet and Generative Adversarial Network (GAN).

In yet another embodiment of the present disclosure, a method is disclosed. The method comprises determining, by processing circuitry, for a vocal track, at least one of a genre and a set of musical instruments to be added to the vocal track. The method further comprises generating, by the processing circuitry, in conformity with the genre, an audio tone for each musical instrument of the set of musical instruments and obtaining, by the processing circuitry, a refined temporal sequence for the audio tone based on one or more temporal dependencies associated with the audio tone. Further, the method comprises generating, by the processing circuitry, an audio waveform using the refined temporal sequence, and generating, by the processing circuitry, based on the vocal track and the audio waveform generated for each musical instrument of the set of musical instruments, an audio track.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates an environment for generative addition of musical instrument tones to songs, consistent with disclosed embodiments of the present disclosure;

FIG. 2 is a block diagram of a training controller of the environment of FIG. 1, consistent with disclosed embodiments of the present disclosure;

FIG. 3 is a block diagram of an implementation controller of the environment of FIG. 1, consistent with disclosed embodiments of the present disclosure;

FIGS. 4A and 4B, collectively, represents a flowchart that illustrates a method for training an audio synthesis model of the environment of FIG. 1, consistent with disclosed embodiments of the present disclosure;

FIGS. 5A and 5B, collectively, represents a flowchart that illustrates a method for generative addition of musical instrument tones to songs, consistent with disclosed embodiments of the present disclosure; and

FIG. 6 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview:

Conventionally, to add musical instrument tones retrospectively to recorded songs, exclusively the musical instrument tones are recorded and then the recorded musical instrument tones are manually mixed with the recorded song using a mixer. This approach is still time-consuming and labor-intensive. Additionally, this approach may often be plagued by latency, making it inefficient for real-time music production. In recent times, sound-generating tools have made significant strides in various areas of the music industry and may be used to generate musical instrument tones or may help re-create the original composition. Examples of such tools may include Digital Audio Workstations (DAWs), Artificial Intelligence Virtual Artist (AIVA), Suno, or the like.

These tools rely heavily on existing pre-recorded musical instrument tones to understand associated harmonic, rhythmic, and melodic structures. This dependency leads to the mere addition of the pre-recorded musical instrument tones to the song without it adhering to the genre of the song, leading to an undesired output. Despite being able to generate the song, such conventional approaches lack the intuitive understanding of contextual awareness such as emotional depth, cultural context, and creative inspiration of the song. The output song thus generated may sometimes sound generic or formulaic, lacking the subtleties that make human-made music unique. Therefore, it could be inferred that the traditional music generation tools lack the ability to adapt to the contextual awareness, limiting them to simply replicate pre-recorded sounds without conforming the musical instrument tone to the genre of the song.

The present disclosure overcomes these limitations by offering a different technique for the generative addition of musical instrument tones to songs. In this approach, for a vocal track (e.g., a song), a genre of the vocal track and a list of musical instruments to be added to the vocal track are determined. The list of musical instruments is validated to be aligned with the genre. Further, in conformity with the genre, musical instrument tones are generated and added in real-time to the vocal track to produce an audio track (e.g., a new song). For example, initially, an audio tone is generated for each musical instrument in conformity with the genre. The audio tone is generated using an iteratively trained audio synthesis model. The audio synthesis model may be a combination of WaveNet and Generative Adversarial Network (GAN).

The audio synthesis model is trained using an audio dataset including various audio tracks. The training of the audio synthesis model may include extraction of audio features for each audio track, segmentation of each audio track into musical instrument tracks, identification of instrument tones for the musical instrument tracks, and determination of a reference genre and one or more musical instruments of each audio track based on the extracted audio features, the segmented musical instrument tracks, and the identified instrument tones. Further, the training may include generation of audio tones using the audio synthesis model for the musical instruments in conformity with the reference genre based on the identified instrument tones, with the audio synthesis model being iteratively trained based on the instrument tones identified for each remaining audio track of the audio dataset.

The authentic audio tone generated for each musical instrument is converted into a spectrogram (e.g., a time-frequency representation). The spectrogram is processed based on temporal dependencies to obtain a refined temporal sequence for each audio tone. An audio waveform is created based on the refined temporal sequence. Further, based on the input vocal track and the audio waveform generated for each musical instrument, the audio track (e.g., the new song) is generated. For example, a Simple Additive Mixing (SMA) operation is executed on the vocal track and the audio waveform generated for each musical instrument to generate the audio track.

The present disclosure may thus allow for a real-time generative addition of the musical instrument tones to songs. The musical instrument tones generated in real-time align seamlessly with the genre of the vocal track. As these tones are generated using the trained audio synthesis model, feedback-driven adjustments lead to continuous improvements, resulting in more convincing and musically authentic sounds. Additionally, the refined temporal sequencing of the musical instrument track ensures smooth transitions between time intervals, preserving information flow and enhancing both harmony and rhythm. The generated instrument tones are integrated into the vocal track, creating a cohesive and complete musical composition. In this way, the generative process of adding musical instrument tones produces highly realistic audio with intricate details and a dynamic range, tailored to the input vocal track. Further, the generative addition of musical instrument tones of the present disclosure is devoid of any human intervention. Therefore, human errors may also be avoided. The application area of the present disclosure may include music production and any other domain where musical instrument tones are required to be added retrospectively to songs. It is appreciated that the human mind is not equipped to conceptualize and engineer accurate, effective, dynamic, and real-time generative addition of the musical instrument tones to songs, with the tones conforming to the genre of the song, given the digital interconnectedness of generative addition of musical instrument tones to songs.

### FIGURE DESCRIPTION

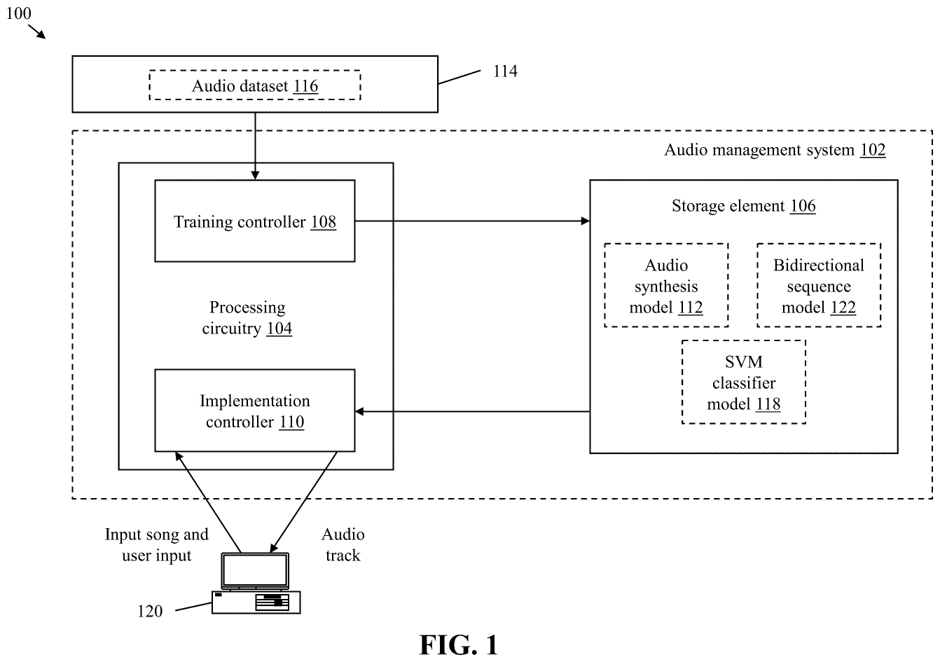

FIG. 1 is a schematic diagram that illustrates an environment 100 for generative addition of musical instrument tones to songs, consistent with disclosed embodiments of the present disclosure.

Conventional addition of musical instrument tones to a song requires the artists to either re-record the song with the additional musical instrument tone or separately record the additional musical instrument tones and mix them with the original song to generate the desired output song. The mixing is typically done using a mixing console or a digital audio workstation (DAW). These approaches involve human intervention, rendering the process time-consuming, complicated, and error prone. To overcome these challenges, an automated and real-time generative tone addition technique is disclosed in the present disclosure.

The environment 100 may include an audio management system 102 that may be configured to execute the automated and real-time generative tone addition technique. For example, the audio management system 102 may be configured to determine, for a vocal track, a genre and a set of musical instruments to be added to the vocal track, generate a musical instrument tone for each musical instrument in conformity with the genre, and add the generated musical instrument tones to the vocal track to generate a new song (e.g., an audio track). The musical instrument tones may be added either throughout the vocal track or at specific time intervals of the vocal track.

In the present disclosure, the generated tones seamlessly align with the genre of the original track, offering several advantages including improved musical authenticity and smooth temporal sequencing that preserves rhythm and harmony. The generated instrument tones are integrated directly into the vocal track, creating a cohesive and polished composition without the need for manual recording or mixing. The generative tone addition technique is devoid of any human intervention. Therefore, human errors may also be avoided. The generative tone addition technique of the present disclosure thus provides a more efficient, accurate, and scalable alternative to conventional methods.

### Audio Management System 102:

To execute the aforementioned operations, the audio management system 102 may include processing circuitry 104 and a storage element 106. The storage element 106 may correspond to hardware storage (for example, hard drive, solid-state drive, or the like) or cloud storage (for example, cloud services). The processing circuitry 104 may include suitable logic, circuitry, interfaces, and/or code, executable by the circuitry, that may be configured to generatively add musical instrument tones to vocal tracks to generate new songs. The operations of the processing circuitry 104 may be divided into two parts: a training part and an implementation part. The processing circuitry 104 may include a training controller 108 and an implementation controller 110 that may be configured to execute the training operations and the implementation operations of the processing circuitry 104, respectively.

### Training Controller 108:

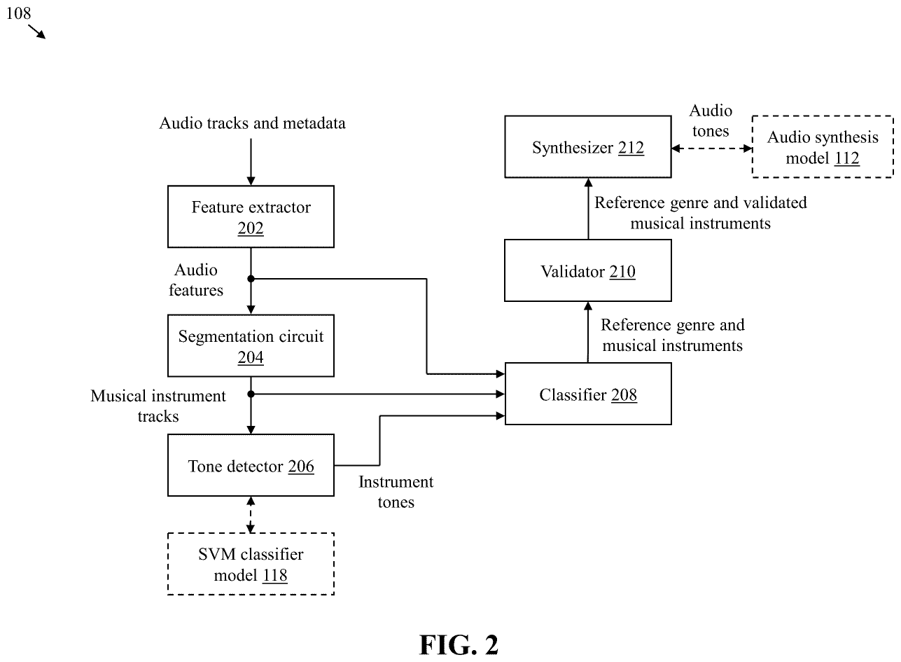

The training controller 108 may include suitable logic, circuitry, interfaces, and/or code, executable by the circuitry, that may be configured to train an audio synthesis model 112. The audio synthesis model 112 is trained to generate audio tones for various musical instruments in conformity with different genres. The training controller 108 may be further configured to store the trained audio synthesis model 112 in the storage element 106. In an embodiment, the audio synthesis model 112 corresponds to a combination of WaveNet and Generative Adversarial Network (GAN). The audio synthesis model 112 is described in detail in conjunction with FIG. 2.

The environment 100 may further include a database 114 to facilitate the training of the audio synthesis model 112. The database 114 may be hosted on cloud storage (e.g., cloud services). Alternatively, the database 114 may be stored in a storage element (e.g., the storage element 106) native to the audio management system 102. The database 114 may be configured to store an audio dataset 116. The audio dataset 116 may include a plurality of audio tracks and metadata associated with each audio track of the plurality of audio tracks. In an embodiment, the metadata associated with an audio track may include at least one of a genre (e.g., pop, rock, classical, jazz, or the like), a title, artist information, an album, release information, a duration, a time stamp, producer information, and a set of musical instruments (e.g., guitar, piano, drums, or the like) included in the corresponding audio track. In several embodiments, the metadata may also include audio properties (e.g., spectral data, rhythm and tempo, volume fluctuations and dynamics), track structure (e.g., verse, chorus, bridge, key, and scale), timbre and sound profiles (e.g., a bright trumpet or a smooth saxophone), or the like. The training controller 108 may train the audio synthesis model 112 using the audio dataset 116. By incorporating the comprehensive audio dataset 116, the audio synthesis model 112 may be better equipped to generate highly accurate, genre-specific, and musically cohesive instrument tones, ultimately resulting in high-quality music production.

To train the audio synthesis model 112 using the audio dataset 116, the training controller 108 may execute various operations. For example, the training controller 108 may be configured to process the plurality of audio tracks from the audio dataset 116. The audio tracks utilized for the training of the audio synthesis model 112 are hereinafter referred to as “training audio tracks”. For a training audio track of the audio dataset 116, the training controller 108 may be configured to extract a first set of audio features. In an embodiment, the first set of audio features may include at least one of rhythm, pitch, beat, and tone of the training audio track. However, in other embodiments, different audio features may be extracted.

The training controller 108 may be further configured to segment the training audio track into one or more musical instrument tracks based on the first set of audio features. Further, the training controller 108 may be configured to extract a second set of features for each training audio track. The second set of features may include at least one of Mel-Frequency Cepstral Coefficients (MFCC), rhythmic patterns, pitch contours, harmonic structures, spectral centroid, and spectral bandwidth. The training controller 108 may be further configured to identify one or more instrument tones for the one or more musical instrument tracks, respectively. The one or more instrument tones for the one or more musical instrument tracks, respectively, are identified based on the second set of features. In an embodiment, the training controller 108 may identify the one or more instrument tones for the one or more musical instrument tracks, respectively, using a Support Vector Machine (SVM) classifier model 118. The storage element 106 may be configured to store the SVM classifier model 118. The SVM classifier model 118 is described in detail in conjunction with FIG. 2.

The training controller 108 may be configured to determine a reference genre and one or more musical instruments of the training audio track based on the first set of audio features, the one or more musical instrument tracks, and the one or more instrument tones. The training controller 108 may be further configured to generate, using the audio synthesis model 112, one or more audio tones for the one or more musical instruments, respectively, in conformity with the reference genre based on the identified one or more instrument tones.

In an embodiment, the training controller 108 may be further configured to validate compatibility between the reference genre and each of the one or more musical instruments. Further, an audio tone, of the one or more audio tones, for one of the one or more musical instruments is generated based on the successful validation of the compatibility between the reference genre and the corresponding musical instrument. For example, a rock song might be expected to include electric guitar, bass, and drums, but not a saxophone or violin. If an identified musical instrument does not match the expected genre, the identified musical instrument may either be ignored or replaced with a more suitable instrument. Such validation prevents the generation of out-of-context sounds, helping maintain the integrity of the genre while refining the pool of instrument tracks.

The above-mentioned operations are repeated for each remaining training audio track of the plurality of training audio tracks, and the audio synthesis model 112 is iteratively trained based on the one or more instrument tones identified for each remaining training audio track. In several embodiments, the audio synthesis model 112 is trained further based on the metadata associated with each training audio track of the plurality of training audio tracks. The trained audio synthesis model 112 may then facilitate musical instrument tone synthesis for a vocal track. The operations of the training controller 108 are explained in detail in conjunction with FIG. 2.

### Implementation Controller 110:

The implementation controller 110 may be configured to receive an input song and a user input. The user input may define a genre of the input song and/or a set of musical instruments to be added to the input song. The environment 100 may further include a user device 120 that is coupled to the processing circuitry 104 (e.g., the implementation controller 110). The user device 120 may correspond to a cellphone, a laptop, a tablet, a phablet, a desktop, a computer, or the like. The user device 120 may be associated with a user (not shown). The user device 120 may include suitable logic, circuitry, interfaces, and/or code, executable by the circuitry, that may be configured to perform one or more operations for interacting with the processing circuitry 104 (e.g., the implementation controller 110). For example, the user device 120 may be used by the user to provide the input song and the user input to the processing circuitry 104 (e.g., the implementation controller 110).

In several embodiments, the input song may correspond to a vocal track. In such a scenario, based on the user input, the implementation controller 110 may be configured to determine, for the vocal track, at least one of the genre and the set of musical instruments to be added to the vocal track. Further, the implementation controller 110 may be configured to generate, in conformity with the genre, an audio tone for a musical instrument of the set of musical instruments. The implementation controller 110 may generate the audio tone in conformity with the genre using the audio synthesis model 112. The audio tone may be a time-domain signal. Further, the implementation controller 110 may be configured to obtain the refined temporal sequence for the audio tone based on one or more temporal dependencies associated with the audio tone.

In an embodiment, the implementation controller 110 may be configured to generate, for the musical instrument, a spectrogram that is a time-frequency representation of the audio tone generated for the corresponding musical instrument. The spectrogram may be generated based on a Short-Time Fourier Transform (STFT) operation on the audio tone. To generate the spectrogram, the implementation controller 110 may be further configured to execute the STFT operation on the audio tone to generate a complex spectrogram that includes amplitude information and phase information. Further, the implementation controller 110 may be configured to extract an amplitude spectrogram from the complex spectrogram based on the amplitude information, and transform the amplitude spectrogram into a time-frequency domain. The implementation controller 110 may be further configured to process the spectrogram based on the one or more temporal dependencies to obtain the refined temporal sequence for the audio tone.

The implementation controller 110 may obtain the refined temporal sequence using a bidirectional sequence model 122. The storage element 106 may be configured to store the bidirectional sequence model 122. In an embodiment, the bidirectional sequence model 122 may correspond to a Bidirectional Long Short-Term Memory (Bi-LSTM) model. The Bi-LSTM model is a type of recurrent neural network (RNN) that processes input sequences in both forward and backward directions. The combination of Bi-LSTM and WaveGAN enhances both the quality and realism of the generated audio tones. The bidirectional sequence model 122 is described in detail in conjunction with FIG. 2.

The implementation controller 110 may be further configured to generate an audio waveform using the refined temporal sequence obtained for the audio tone. The implementation controller 110 may generate the audio waveform by executing an Inverse Short-Time Fourier Transform (ISTFT) operation on the refined temporal sequence. The audio waveform may thus be a time-domain audio signal. The audio waveform may thus correspond to the musical instrument tone. Audio waveforms are generated for each remaining musical instrument of the set of musical instruments in a similar manner as described above.

The implementation controller 110 may be further configured to generate, based on the vocal track and the audio waveform generated for each musical instrument of the set of musical instruments, an audio track (e.g., a new song). To generate the audio track, the implementation controller 110 may be further configured to execute a Simple Additive Mixing (SMA) operation on the vocal track and the audio waveform generated for each musical instrument of the set of musical instruments. The audio track thus corresponds to the original vocal track with the musical instrument tones added therein.

In an embodiment, the musical instrument tones may be added throughout the vocal track. In another embodiment, the user input may further define a time interval within the input song (e.g., the vocal track) where the set of musical instruments is to be added, and the implementation controller 110 may generate the audio track such that the audio waveform of each of the set of musical instruments is added to the vocal track in synchronization with the defined time interval. Further, the implementation controller 110 may be configured to provide the audio track to the user device 120 for presenting to the user. In an embodiment, the implementation controller 110 may render a user interface (UI) that enables the playing of the audio track.

Although it is described that the input song corresponds to a vocal track, the scope of the present disclosure is not limited to it. In several embodiments, the input song may be a combination of a vocal track and at least one musical instrument tone. In such a scenario, the implementation controller 110 may be configured to process the input song to determine the vocal track and the at least one musical instrument tone present in the input song and separate the vocal track and the at least one musical instrument tone. The vocal track may be utilized to generate the audio track (e.g., the new song) in the manner described above. In an embodiment, the at least one musical instrument tone may be retained in the audio track. In another embodiment, the at least one musical instrument tone may be absent in the audio track.

The scope of the present disclosure is not limited to the input song corresponding to a vocal track. In numerous embodiments, the input song may exclusively include musical instrument tones. In such a scenario, the audio track (e.g., the new song) may be generated in the same manner described above, with the existing musical instrument tones replacing the vocal track.

FIG. 2 is a block diagram of the training controller 108, consistent with disclosed embodiments of the present disclosure. The training controller 108 may be configured to process the audio dataset 116 to generate the audio tones in conformity with reference genres. As illustrated in FIG. 2, the training controller 108 may include a feature extractor 202, a segmentation circuit 204, a tone detector 206, a classifier 208, a validator 210, and a synthesizer 212.

The feature extractor 202 may be coupled to the database 114. The feature extractor 202 may include suitable logic, circuitry, interfaces, and/or code, executable by the circuitry, that may be configured to perform one or more operations. For example, the feature extractor 202 may be configured to retrieve, from the database 114, the audio dataset 116 including the plurality of training audio tracks. The feature extractor 202 may be configured to extract the first set of audio features for each training audio track. The first set of audio features may include rhythm, pitch, beat, tone, or the like. In an embodiment, the feature extractor 202 is an autoencoder. The autoencoder is a type of neural network that learns to compress data in an unsupervised way. The autoencoder may be trained to understand the underlying structures and relationships within the music. The autoencoder may comprise an encoder and a decoder. During training, the encoder reduces the data's dimensions, capturing key features, while the decoder reconstructs the input from this compressed form. Once the autoencoder is trained, the trained autoencoder may extract compressed, meaningful representations of the audio tracks, such as rhythm, pitch, and tone, in a smaller and more efficient format in a latent space. These audio features are essential for reducing computational complexity while retaining the important aspects of the audio tracks.

The segmentation circuit 204 may be coupled to the feature extractor 202. The segmentation circuit 204 may include suitable logic, circuitry, interfaces, and/or code, executable by the circuitry, that may be configured to perform one or more operations. For example, the segmentation circuit 204 may be configured to receive, from the feature extractor 202, the first set of audio features (hereinafter referred to as “audio features”) extracted for each training audio track of the audio dataset 116. Based on the audio features extracted for each training audio track, the segmentation circuit 204 may be further configured to segment the corresponding training audio track into one or more musical instrument tracks. In an embodiment, the segmentation circuit 204 may be configured to implement a clustering technique, which when applied to the extracted audio features, group similar patterns in the latent space into distinct clusters, where each cluster represents a different musical instrument or sound component. For example, the segmentation circuit 204 may be configured to cluster segments representing drums, guitar, piano, vocals, or the like. In an embodiment, clustering techniques such as k-means or hierarchical clustering are utilized to obtain distinct clusters, splitting the audio features into one or more musical instrument tracks. This segmentation is essential as each instrument may then be processed independently.

The tone detector 206 may be coupled to the segmentation circuit 204 and the storage element 106. The tone detector 206 may include suitable logic, circuitry, interfaces, and/or code, executable by the circuitry, that may be configured to perform one or more operations. For example, the tone detector 206 may be configured to receive, from the segmentation circuit 204, the one or more musical instrument tracks (hereinafter referred to as “musical instrument tracks”) segmented from each training audio track. For each training audio track, the tone detector 206 may be further configured to extract a second set of features and identify one or more instrument tones (hereinafter referred to as “instrument tones”) for the corresponding one or more musical instrument tracks, respectively, based on the second set of audio features. The second set of features may include MFCC, rhythmic patterns, pitch contours, harmonic structures, spectral centroid, spectral bandwidth, or the like. The tone detector 206 identifies the difference between a lead guitar solo, a rhythm guitar, or a piano melody. In an embodiment, the tone detector 206 may execute the aforementioned operations by using the SVM classifier model 118. The SVM classifier model 118, analyzes the second set of audio features to classify and label each musical instrument sound. By accurately extracting and classifying the tones of each instrument, the tone detector 206 ensures that only correct sounds are passed on to the generation phase, reducing the risk of misclassification or erroneous sound generation. This identification ensures that the role of each instrument is clearly defined, leading to error-free generation of the instrument tones.

The classifier 208 may be coupled to the feature extractor 202, the segmentation circuit 204, and the tone detector 206. The classifier 208 may include suitable logic, circuitry, interfaces, and/or code, executable by the circuitry, that may be configured to perform one or more operations. For example, the classifier 208 may be configured to receive the audio features, the musical instrument tracks, and the instrument tones associated with each training audio track from the feature extractor 202, the segmentation circuit 204, and the tone detector 206, respectively. Based on the audio features, the musical instrument tracks, and the one or more instrument tones associated with each training audio track, the classifier 208 may be configured to determine a reference genre and one or more musical instruments (hereinafter referred to as “musical instruments”) of each training audio track. For example, the classifier 208 may identify whether the song is rock and whether it includes musical instruments like lead guitar, bass, and drums. The classifier 208 may generate the reference genre and the musical instruments by understanding the relation between the features of the music with both its genre and the instruments. By recognizing patterns in the music, the classifier 208 ensures that the correct instrument and genre labels are used, which is crucial for maintaining genre consistency when the instrument tones are processed further.

The validator 210 may be coupled to the classifier 208. The validator 210 may include suitable logic, circuitry, interfaces, and/or code, executable by the circuitry, that may be configured to perform one or more operations. For example, the validator 210 may be configured to receive the reference genre and the musical instruments determined for each training audio track from the classifier 208. The validator 210 may be configured to validate compatibility between the reference genre and each musical instrument. In an embodiment, the validator 210 is a compatibility checker which ensures that the musical instruments align with typical genre conventions. To achieve this, the validator 210 may incorporate a predefined genre-to-instrument mapping that links genres to specific musical instruments. For example, a rock song is expected to have instruments like electric guitar, bass, and drums, but not saxophone or violin. If an instrument does not align with the genre, it is either ignored or replaced with a more suitable one. This helps ensure that the musical instrument is correct and fits the style of the genre. This validation step helps avoid adding sounds that do not match the genre, keeping the music true to its style and refining the instruments.

The synthesizer 212 may be coupled to the validator 210 and the storage element 106. The synthesizer 212 may include suitable logic, circuitry, interfaces, and/or code, executable by the circuitry, that may be configured to perform one or more operations. For example, the synthesizer 212 may be configured to receive the reference genre and validated musical instruments associated with each training audio track from the validator 210. For each training audio track, the synthesizer 212 may be configured to generate one or more audio tones (hereinafter referred to as “audio tones” for the validated musical instruments, in conformity with the reference genre. The synthesizer 212 may generate the audio tones using the audio synthesis model 112. The audio synthesis model 112 is iteratively trained based on the instrument tones identified for each remaining training audio track of the audio dataset 116 and the metadata associated with each training audio track. The synthesizer 212 may be configured to store the trained audio synthesis model 112 in the storage element 106. The trained audio synthesis model 112 may then facilitate musical instrument tone synthesis for songs.

In one embodiment, the audio synthesis model 112 includes a combination of WaveNet and GAN (collectively referred to as “WaveGAN”). WaveNet is a deep neural network architecture designed to process temporal audio sequences by learning from the audio tracks and capturing the time dependencies and audio patterns of each musical instrument. For example, WaveNet may be responsible for generating the audio tones from the validated raw audio tracks, along with their metadata. The output from the WaveNet is fed to the GAN which consists of a generator and a discriminator.

The generator applies convolutional layers to capture intricate audio features from the audio tracks and generates realistic audio tones for the instruments (such as guitar riffs for rock or piano melodies for classical music). The audio tones generated by the generator are referred to as “synthetic audio tones”. The discriminator may receive original audio samples from the audio dataset 116 along with synthetic audio tones from the generator. The discriminator distinguishes between real samples and the synthetic audio produced by the generator. The feedback generated by the discriminator helps the generator iteratively improve, pushing the generator to produce increasingly realistic audio tones.

The generator obtains a latent noise vector (a random set of values) from the input song and learns to transform this noise vector into meaningful audio output by passing it through a series of transformations that structure the noise vector into the audio tone. These series of transformations utilize transposed convolution layers (or deconvolution layers), which increase the resolution and detail of the audio, helping build more complex and refined audio waveforms over time. Unlike regular convolution, which reduces the input size, transposed convolution layers work by increasing the size and detail of the latent audio features. In the case of audio, this means adding more detail and accuracy to the audio tones over time. Each layer of the transposed convolution layers creates feature maps, representing intermediate stages of the audio tone, capturing aspects such as rhythm, melody, and beat, thus refining the audio output. The feature maps play a crucial role by highlighting key audio features, allowing the audio synthesis model 112 to produce meaningful and structured sound. In the final stage, the last feature map from the transposed convolution layers is converted into a raw audio tone, which serves as the generated audio sample. In an embodiment, the generator includes fractional striding to up-sample the generated audio sample, increasing its resolution. This allows the generator to create more detailed and realistic audio samples.

The generated audio sample output is discriminated by the discriminator to generate a probability score as output indicating whether the input audio waveform is real (e.g., from the audio dataset 116) or fake (e.g., generated by the generator). In an embodiment, the discriminator includes striding to down-sample the generated audio tone. The final output generated by the discriminator is a binary classification (e.g., real or fake). This output trains the generator to produce tones that closely resemble real-world sound.

The audio synthesis model 112 may further be configured to learn genre-specific features, to generate instrument tones that sound appropriate within a given genre's musical framework (e.g., rock, jazz, classical). For example, a lead guitar generated for a rock genre would have a distinctly different tone than one generated for a jazz or pop genre. The realistic audio tones generated using the audio synthesis model 112 undergo batch normalization, which standardizes the output from the convolution layers, ensuring the activations have a mean of ‘0’ and a variance of ‘1’. This stabilizes the training, accelerates learning, and helps prevent overfitting, allowing the model to converge to a better solution more efficiently.

The audio synthesis model 112 (as discussed in FIG. 1) is a WaveGAN model configured to undergo iterative adversarial training to generate the audio tones for each musical instrument. The adversarial dynamic between the generator and the discriminator of the audio synthesis model 112 ensures that the generated audio tones are progressively more realistic. For example, if the input song contains a lead guitar in a rock genre, WaveGAN learns to generate new, realistic guitar riffs in line with the stylistic norms of rock music. Similarly, if a piano is part of a jazz track, the WaveGAN learns to generate new piano sequences that fit jazz harmonics and rhythms. Once trained, WaveGAN generates raw audio waveforms that represent new tones for each musical instrument. The final audio tone is a combination of the musical instrument tracks, each of which has been enhanced or augmented with new tones created by WaveGAN.

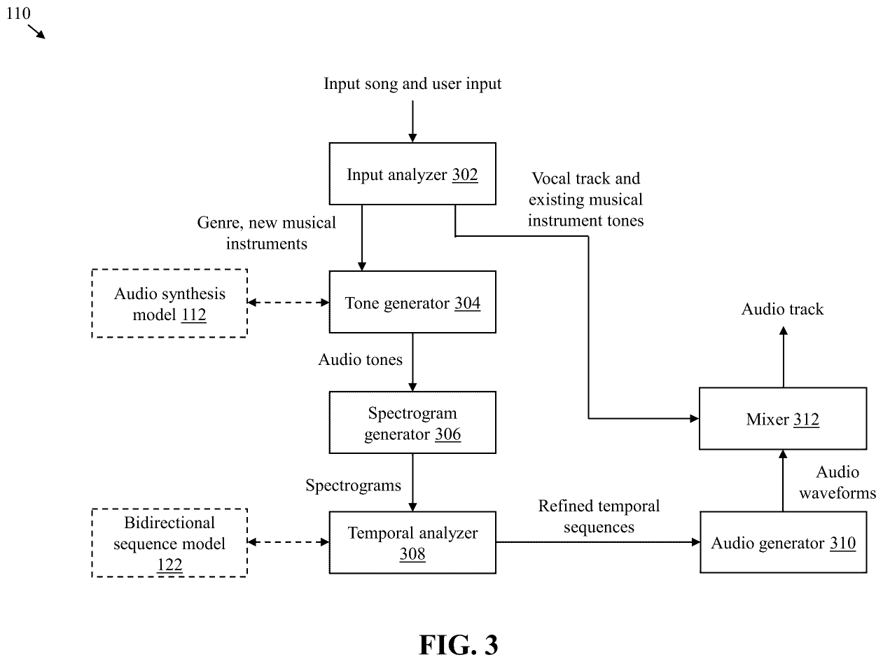

FIG. 3 is a block diagram of the implementation controller 110, consistent with disclosed embodiments of the present disclosure. As illustrated in FIG. 3, the implementation controller 110 includes an input analyzer 302, a tone generator 304, a spectrogram generator 306, a temporal analyzer 308, an audio generator 310, and a mixer 312.

The input analyzer 302 may be coupled to the user device 120. The input analyzer 302 may include suitable logic, circuitry, interfaces, and/or code, executable by the circuitry, that may be configured to perform one or more operations. For example, the input analyzer 302 may be configured to receive the input song and user input from the user device 120. The user input may define the genre of the input song and the set of musical instruments to be added to the input song. In some embodiments, the input song may include the vocal track and musical instrument tones. The input analyzer 302 may be configured to process the input song to determine the vocal track and the musical instrument tones present in the input song. Further, the input analyzer 302 may be configured to separate the vocal track and the musical instrument tones present in the input song (hereinafter referred to as “existing musical instrument tones”). For the vocal track, the input analyzer 302 may be configured to determine the genre and the set of musical instruments to be added to the vocal track. The set of musical instruments to be added to the vocal track is hereinafter referred to as “new musical instruments”.

The tone generator 304 may be coupled to the storage element 106 and the input analyzer 302. The tone generator 304 may include suitable logic, circuitry, interfaces, and/or code, executable by the circuitry, that may be configured to perform one or more operations. For example, the tone generator 304 may be configured to receive the determined genre and the new musical instruments from the input analyzer 302. The tone generator 304 may be configured to generate, in conformity with the genre, audio tones for the new musical instruments. The audio tones may be generated for the new musical instruments in conformity with the genre using the audio synthesis model 112. The audio tones are time-domain signals.

The spectrogram generator 306 may be coupled to the tone generator 304. The spectrogram generator 306 may include suitable logic, circuitry, interfaces, and/or code, executable by the circuitry, that may be configured to perform one or more operations. For example, the spectrogram generator 306 may be configured to receive the audio tones from the tone generator 304. The spectrogram generator 306 may be configured to generate spectrograms for the new musical instruments. A spectrogram is a time-frequency representation of the audio tone generated for the corresponding musical instrument.

To generate a spectrogram, the spectrogram generator 306 may execute various operations. For example, the spectrogram generator 306 may be further configured to execute the STFT operation on the corresponding audio tone to generate a complex spectrogram that includes amplitude information and phase information. During this process, the continuous audio signal is initially broken down into shorter, overlapping segments, commonly known as “frames” or “windows”. These frames typically last only a few milliseconds, enabling the capture of time-localized frequency information. Each frame is processed by applying a Fourier transform, which converts the time-domain signal into the frequency domain. This transformation results in a spectrum for each frame, illustrating the presence of various frequencies within that specific time segment. The overlapping nature of the frames ensures a seamless transition between time intervals, effectively preserving crucial information and preventing any loss during the analysis. This process results in the formation of a complex spectrogram containing both amplitude and phase information for every frequency component at each time step.

The spectrogram generator 306 may be further configured to extract the amplitude spectrogram from the complex spectrogram based on the amplitude information. In other words, the complex spectrogram is processed further to retain the amplitude information and discard the phase information. The amplitude spectrogram shows the intensity (or strength) of different frequency components at each point in time. This simplifies the representation by focusing solely on the strength of the frequencies without considering their phase relationship. The resulting amplitude spectrogram is a matrix where each value corresponds to the intensity of a particular frequency at a given time. This intensity data is then used to create the visual representation of the spectrogram. In simpler terms, the spectrogram visualizes the different frequencies in the sound and their evolution with respect to time. By turning raw audio into spectrograms, the unique patterns of each instrument's sound are understood, including features such as pitch, rhythm, and tone. The spectrogram generator 306 may be further configured to transform the amplitude spectrogram into a time-frequency domain.

The temporal analyzer 308 may be coupled to the spectrogram generator 306 and the storage element 106. The temporal analyzer 308 may include suitable logic, circuitry, interfaces, and/or code, executable by the circuitry, that may be configured to perform one or more operations. For example, the temporal analyzer 308 may be configured to receive the spectrograms from the spectrogram generator 306. The temporal analyzer 308 may be further configured to process the spectrograms based on the temporal dependencies to obtain refined temporal sequences for the audio tones. In other words, the temporal analyzer 308 may be further configured to obtain the refined temporal sequences for the audio tones based on the temporal dependencies associated with the audio tones. The temporal analyzer 308 obtains the refined temporal sequences using the bidirectional sequence model 122.

The bidirectional sequence model 122 (e.g., the Bi-LSTM model) may process sequences in both forward and backward directions by capturing temporal dependencies. The Bi-LSTM model improves the coherence of each instrument's tone by considering both past and future time steps. This helps in generating smoother transitions between notes and more natural-sounding tones for each instrument, ensuring that each tone sounds more musically cohesive. The combination of Bi-LSTM and WaveGAN enhances both the quality and realism of the generated audio tones.

The spectrogram for each instrument represents the distribution of frequencies across time. This spectrogram is segmented into sequential frames. These frames capture the amplitude of different frequency components at each moment, providing a detailed view of the sound structure. Each instrument's spectrogram is fed into the network as a sequence of these time frames. These sequences of time frames are processed bidirectionally by the Bi-LSTM model. The Bi-LSTM consists of a forward LSTM and a backward LSTM to process input sequences in both forward and backward directions, respectively.

The forward LSTM processes the spectrogram sequence in a forward direction, i.e., analyzes the frames from beginning to end. The forward LSTM uses hidden states and cell states to maintain memory over time allowing it to capture long-term dependencies in the data, thus helping understand the influence of past information in the present. The forward LSTM refines the sequence, outputting a more informative representation of the audio features based on the past context it has observed, giving a clearer picture of the audio based on the past context. The backward LSTM does the opposite, processing the frames in the reverse direction, starting from the end and going back to the beginning. This backward pass allows the Bi-LSTM to retain the memory of future context, utilizing the hidden state and cell state to track information that comes after a given time step. By processing the sequence in this way, the backward LSTM provides a complementary view of the sequence, refining the information from the perspective of future inputs.

The hidden states are combined at each time step after processing the spectrogram sequence through both the forward and backward LSTMs. The hidden state combination step merges the information from both the forward and backward LSTMs at each point in time. Bi-LSTM gains a more comprehensive understanding of the audio features at each moment in time by integrating both temporal perspectives. This combined hidden state enhances the ability of Bi-LSTM to capture dependencies from both directions, leading to more accurate predictions.

Finally, the network generates the refined temporal sequence for each instrument's tone or feature. This output is a more detailed and context-aware version of the original spectrogram, combining insights from both directions of the sequence. This refined output may then be used for tasks like sound classification, transcription, or synthesis, making it especially useful in complex audio analysis where understanding time-dependent relationships is essential.

### Generative Addition of Acoustic Guitar Tone to the Song:

The generation of the audio tone using the WaveGAN in the audio synthesis model 112 is explained with the example of generating the acoustic Guitar audio tone. WaveGAN uses a detailed process to generate the audio tone of the acoustic guitar based on genre and validated musical instruments. The input to the WaveGAN is an audio dataset 116 of audio tracks that represent different guitar tones, capturing various playing styles like strumming and fingerpicking. These tone pairs help WaveGAN understand the guitar's sound and variations. The input to the WaveGAN also comprises the song as context along with the associated genre. The whole song as a context includes the dynamic structure of music and the evolution of tones over a defined interval.

As discussed earlier in FIG. 2, the WaveGAN comprises the generator and the discriminator for generating authentic audio tones. The generator creates audio tone from random noise, by using 1D convolutional layers to process the input noise and other conditions (tone pairs, context, and genre). These layers create feature maps that capture important audio aspects like frequency and rhythm. The dimensionality of the feature maps is further reduced to generate a summary of the feature maps based on striding. The important feature maps upon summarization are subjected to fractional striding for up-sampling the feature map to improve the audio's resolution.

The generator then reconstructs the audio waveforms that resemble the sound of the acoustic guitar, maintaining the timing and tonal details of how the guitar is played. The reconstruction is performed by transforming a latent vector through several layers of convolution and up-sampling of the features. During training, the generator and discriminator compete, with the discriminator learning to tell apart real and generated audio. This iteration helps the generator continually improve its output, refining its ability to produce realistic guitar sounds.

The realistic audio tones generated by the WaveGAN in a one-dimensional time-domain are segmented and transformed into a frequency domain using STFT to generate a complex spectrogram of the acoustic guitar. The complex spectrogram includes the amplitude and phase information. The complex spectrogram is processed and converted to an amplitude spectrogram representing the amplitude of the spectrogram.

The spectrogram generated for the output audio tone of the acoustic guitar containing audio of strumming a sequence of chords generated by the WaveGAN is fed as input to the Bi-LSTM. The forward LSTM processes this spectrogram in a step-by-step manner, starting from the first chord and moving forward. At each time step, the forward LSTM processes the sound of a single chord. For example, at a first time instance (t=1), the forward LSTM takes the sound of Chord 1 and generates an internal representation of it. When processing Chord 2 at the next time instance (t=2), the forward LSTM analyzes both the sound of Chord 2 and the hidden state from Chord 1. This allows the forward LSTM to remember the sound of Chord 1 while processing Chord 2. As the sequence progresses, the forward LSTM builds up knowledge of earlier chords, allowing it to consider the transitions and variations between them. For example, when processing Chord 5, the forward LSTM still remembers the subtle variations from Chord 2 and Chord 3. By the time the forward LSTM reaches the end of the strumming pattern (the last chord), the forward LSTM produces outputs for each time step (e.g., Output 1 for Chord 1 and Output T for the last chord). These outputs represent a refined understanding of how the sound evolves from the beginning up to that point. The forward LSTM processes each guitar chord in order and remembers everything that happened before to better understand the sound as it plays.

The backward LSTM of the Bi-LSTM processes the same guitar strumming, but in a reverse direction (i.e., starting from the last chord and ending at the first chord). The goal here is to use information about what happens later to understand the working of the earlier chords. The backward LSTM starts with the sound of the last chord that is strummed. For example, at time step t=T, the backward LSTM processes the final chord and generates a hidden state. This hidden state captures information about the final sound of the guitar strumming. When it moves to the second-to-last chord (for example Chord 3), the backward LSTM uses the hidden state from the last chord to refine understanding of Chord 3. This allows the backward LSTM to understand Chord 3 not just in isolation, but also in terms of what happens next (i.e., the sound of the final chord). As it processes earlier chords like Chord 2 and Chord 1, the backward LSTM continues to incorporate information about what happens later in the sequence. By the time the backward LSTM reaches the first chord, the backward LSTM may consider how the strumming pattern ends, which might help refine the interpretation of the initial strum. The outputs generated at each time step (e.g., Output T for the last chord or Output 1 for the first chord) represent a backward-informed view of the sound. The backward LSTM uses future sounds to improve understanding of earlier ones.

In this example of acoustic guitar, the Bi-LSTM adjusts its memory while learning to capture the patterns of guitar strumming. The Bi-LSTM processes the spectrogram of the guitar strumming in two directions: the forward LSTM moves from the first chord to the last, remembering how the chords evolve, while the backward LSTM processes from the last chord back to the first, capturing the future context. As it processes each chord, both the forward and backward LSTMs maintain and update their internal memory (hidden and cell states). After processing the entire sequence, the Bi-LSTM compares its predictions (e.g., the predicted sound evolution) to the actual sound. If there is a difference (e.g., error), the Bi-LSTM adjusts the memory weights of both forward and backward LSTMs to minimize this error, helping better capture the transition between chords. Through iterative training, the Bi-LSTM refines its memory by continuously adjusting the hidden and cell states in both directions. Over time, the model learns to better remember how earlier and later chords relate, allowing it to capture the full structure of the guitar strumming pattern more effectively in the refined temporal sequence.

The audio generator 310 may be coupled to the temporal analyzer 308. The audio generator 310 may include suitable logic, circuitry, interfaces, and/or code, executable by the circuitry, that may be configured to perform one or more operations. For example, the audio generator 310 may be configured to receive the refined temporal sequences from the temporal analyzer 308. The audio generator 310 may be configured to generate audio waveforms for the new musical instruments using the refined temporal sequences. The audio generator 310 generates the audio waveforms by executing an ISTFT operation on the refined temporal sequences. The audio waveforms may thus be time-domain audio signals. The ISTFT is the inverse of the STFT, where the time-frequency information is converted back into a time-domain waveform. In ISTFT, the time frames are slightly overlapping, and during the inverse process, these frames are combined by overlapping and adding them together, smoothing the transitions between adjacent time segments. The result is reconstructed audio waveforms that represent the synthesized tones for new musical instruments. The quality of the reconstructed audio waveforms depends on the processing of the Bi-LSTM model and the refined temporal patterns.

The mixer 312 may be coupled to the audio generator 310 and the input analyzer 302. The mixer 312 may include suitable logic, circuitry, interfaces, and/or code, executable by the circuitry, that may be configured to perform one or more operations. For example, the mixer 312 may be configured to receive the vocal track and the existing musical instrument tones from the input analyzer 302, and the audio waveforms generated for the new musical instruments from the audio generator 310. The mixer 312 may be configured to generate the audio track based on the vocal track and the audio waveforms generated for the new musical instruments. In an embodiment, the existing musical instrument tones may be retained in the audio track. The mixer 312 may be configured to execute the SMA operation on the vocal track, the existing musical instrument tones, and the audio waveforms generated for the new musical instruments to generate the audio track. This mixing ensures that all the instrument tones are perfectly balanced, and the combined result sounds harmonious. In simple terms, if there are multiple frequency bands or different instrument layers, each sound is summed up sample-by-sample. This creates a single audio signal containing the combined information of all the individual tracks. The result is the final audio track, which is a full, reconstructed version of the entire musical performance. The acoustic guitar's output, processed and refined, is blended and added to this final audio track, preserving its tonal qualities and dynamics. This ensures that the guitar's sound is harmoniously integrated with the other instruments or audio layers, resulting in a cohesive and balanced final mix.

In an embodiment, the new musical instrument tones may be added throughout the vocal track. In another embodiment, the user input may further define a time interval within the input song (e.g., the vocal track) where the new musical instruments are to be added, and the mixer 312 may generate the audio track such that the audio waveforms of the new musical instruments are added to the vocal track in synchronization with the defined time interval.

Although not shown, the implementation controller 110 may include an output manager that may be configured to provide the audio track to the user device 120 for presenting to the user.

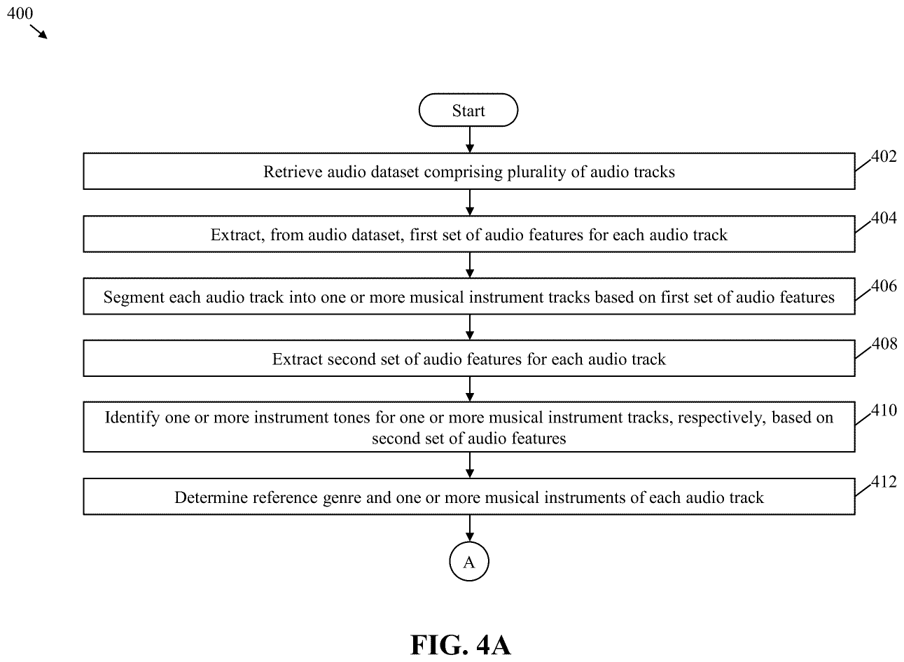

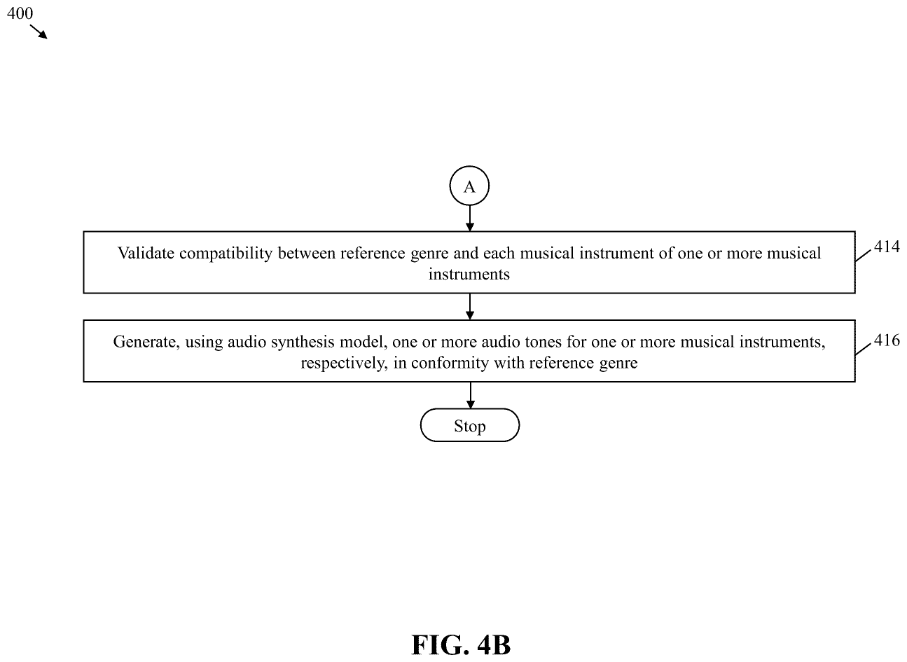

FIGS. 4A and 4B, collectively, represents a flowchart 400 that illustrates a method for training the audio synthesis model 112, consistent with disclosed embodiments of the present disclosure.

Referring to FIG. 4A, at 402, the processing circuitry 104 may be configured to retrieve the audio dataset 116 comprising the plurality of audio tracks. At 404, the processing circuitry 104 may be configured to extract, from the audio dataset 116, the first set of audio features for each audio track. The first set of audio features comprises at least one of rhythm, pitch, beat, and tone of each audio track. At 406, the processing circuitry 104 may be configured to segment each audio track into the one or more musical instrument tracks based on the first set of audio features. At 408, the processing circuitry 104 may be configured to extract the second set of audio features for each audio track. The second set of features comprises at least one of MFCC, rhythmic patterns, pitch contours, harmonic structures, spectral centroid, and spectral bandwidth. At 410, the processing circuitry 104 may be configured to identify the one or more instrument tones for the one or more musical instrument tracks, respectively, based on the second set of audio features. At 412, the processing circuitry 104 may be configured to determine the reference genre and the one or more musical instruments of each audio track.

Referring to FIG. 4B, at 414, the processing circuitry 104 may be configured to validate compatibility between the reference genre and each musical instrument of the one or more musical instruments. At 416, the processing circuitry 104 may be configured to generate, using the audio synthesis model 112, the one or more audio tones for the one or more musical instruments, respectively, in conformity with the reference genre. The aforementioned method is repeated for each remaining audio track, with the audio synthesis model 112 being iteratively trained based on the one or more instrument tones identified for each remaining audio track of the audio dataset 116.

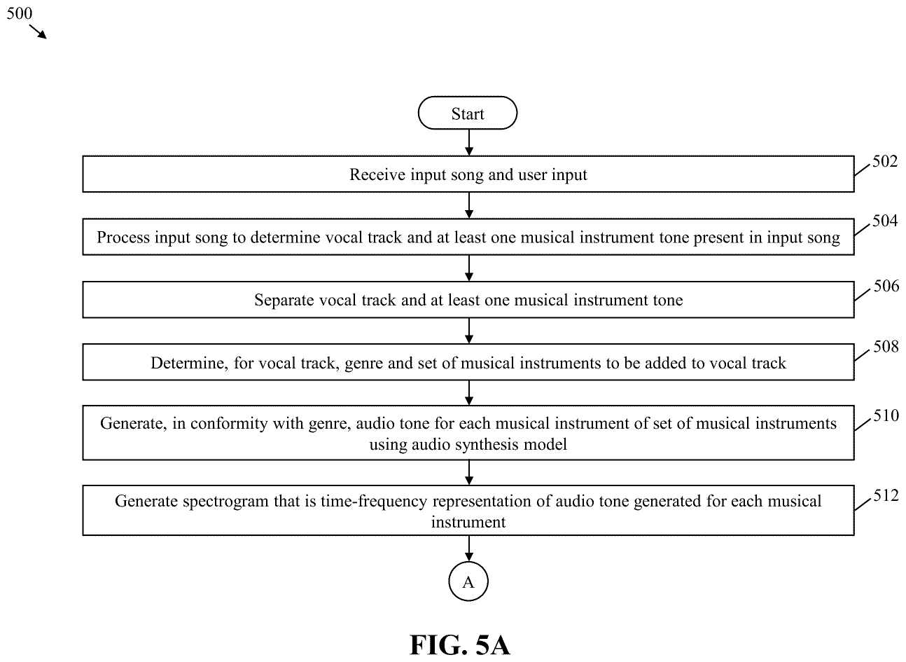

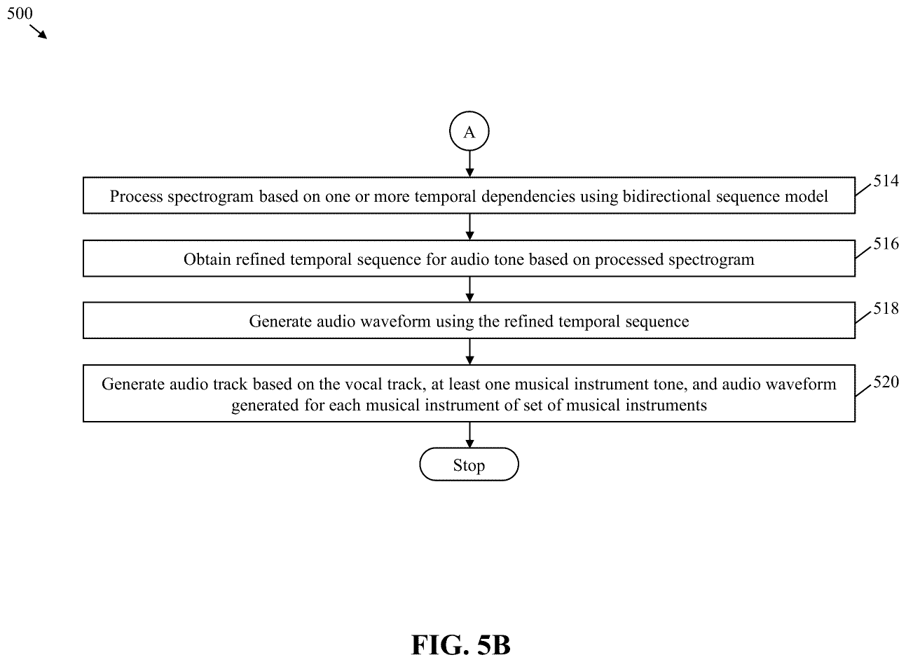

FIGS. 5A and 5B, collectively, represents a flowchart 500 that illustrates a method for generative addition of musical instrument tones to songs, consistent with disclosed embodiments of the present disclosure.

Referring to FIG. 5A, at 502, the processing circuitry 104 may be configured to receive the input song and the user input. At 504, the processing circuitry 104 may be configured to process the input song to determine a vocal track and at least one musical instrument tone present in the input song. At 506, the processing circuitry 104 may be configured to separate the vocal track and the at least one musical instrument tone. At 508, the processing circuitry 104 may be configured to determine, for the vocal track, the genre and the set of musical instruments to be added to the vocal track. At 510, the processing circuitry 104 may be configured to generate, in conformity with the genre, the audio tone for each musical instrument of the set of musical instruments using the audio synthesis model 112. At 512, the processing circuitry 104 may be configured to generate the spectrogram that is a time-frequency representation of the audio tone generated for each musical instrument.

Referring to FIG. 5B, at 514, the processing circuitry 104 may be configured to process the spectrogram based on the one or more temporal dependencies using the bidirectional sequence model 122. At 516, the processing circuitry 104 may be configured to obtain the refined temporal sequence for the audio tone based on the processed spectrogram. At 518, the processing circuitry 104 may be configured to generate the audio waveform using the refined temporal sequence. At 520, the processing circuitry 104 may be configured to generate the audio track based on the vocal track, the at least one musical instrument tone, and the audio waveform generated for each musical instrument of the set of musical instruments.

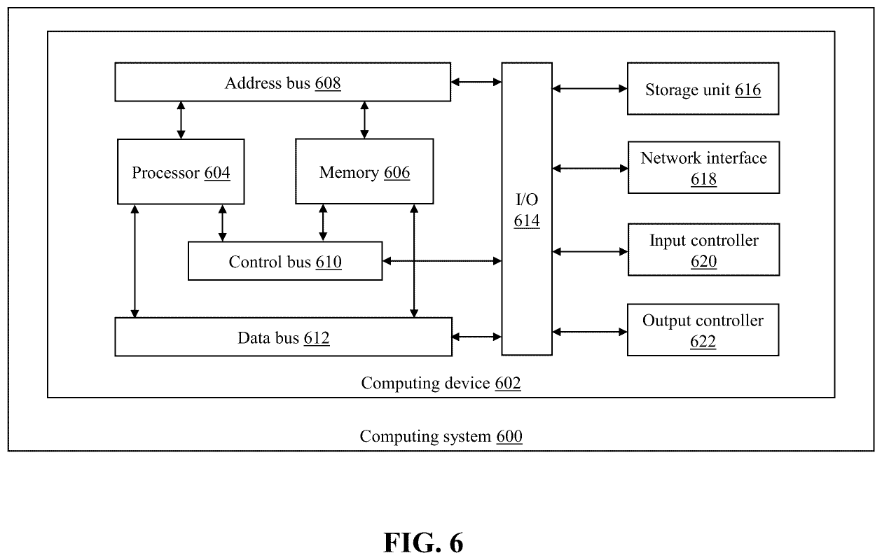

FIG. 6 shows an example computing system 600 for carrying out the methods of the present disclosure, consistent with disclosed embodiments of the present disclosure. Specifically, FIG. 6 shows a block diagram of an embodiment of the computing system 600 according to example embodiments of the present disclosure.

The computing system 600 may be configured to perform any of the operations disclosed herein. The computing system 600 may be implemented as a conventional computer system, an embedded controller, a laptop, a server, a mobile device, a smartphone, a customized machine, any other hardware platform, or any combination or multiplicity thereof. In one embodiment, the computing system 600 is a distributed system configured to function using multiple computing machines interconnected via a data network or bus system.

The computing system 600 includes computing devices (such as a computing device 602). The computing device 602 includes one or more processors (such as a processor 604) and a memory 606. The processor 604 may be any general-purpose processor(s) configured to execute a set of instructions. For example, the processor 604 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 604 may be multiple processing units, a single processing core, multiple processing cores, special purpose processing cores, co-processors, or any combination thereof. The processor 604 may be communicatively coupled to the memory 606 via an address bus 608, a control bus 610, and a data bus 612.

The memory 606 may include non-volatile memories such as a read-only memory (ROM), a programable read-only memory (PROM), an erasable programmable read-only memory (EPROM), a flash memory, or any other device capable of storing program instructions or data with or without applied power. The memory 606 may also include volatile memories, such as a random-access-memory (RAM), a static random-access-memory (SRAM), a dynamic random-access-memory (DRAM), and a synchronous dynamic random-access-memory (SDRAM). The memory 606 may include single or multiple memory modules. While the memory 606 is depicted as part of the computing device 602, a person skilled in the art will recognize that the memory 606 may be separate from the computing device 602.

The memory 606 may store information that may be accessed by the processor 604. For instance, the memory 606 (e.g., one or more non-transitory computer-readable storage mediums, memory devices) may include computer-readable instructions (not shown) that may be executed by the processor 604. The computer-readable instructions may be software written in any suitable programming language or may be implemented in hardware. Additionally, or alternatively, the computer-readable instructions may be executed in logically and/or virtually separate threads on the processor 604. For example, the memory 606 may store instructions (not shown) that when executed by the processor 604 cause the processor 604 to perform operations such as any of the operations and functions for which the computing system 600 is configured, as described herein. Additionally, or alternatively, the memory 606 may store data (not shown) that may be obtained, received, accessed, written, manipulated, created, and/or stored. The data may include, for instance, the data and/or information described herein in relation to FIGS. 1-5. In some implementations, the computing device 602 may obtain from and/or store data in one or more memory device(s) that are remote from the computing system 600.

The computing device 602 may further include an input/output (I/O) interface 614 communicatively coupled to the address bus 608, the control bus 610, and the data bus 612. The data bus 612 may include a plurality of tunnels that may support communication in the environment 100. The I/O interface 614 is configured to couple to one or more external devices (e.g., to receive and send data from/to one or more external devices). Such external devices, along with the various internal devices, may also be known as peripheral devices. The I/O interface 614 may include both electrical and physical connections for operably coupling the various peripheral devices to the computing device 602. The I/O interface 614 may be configured to communicate data, addresses, and control signals between the peripheral devices and the computing device 602. The I/O interface 614 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 614 is configured to implement only one interface or bus technology. Alternatively, the I/O interface 614 is configured to implement multiple interfaces or bus technologies. The I/O interface 614 may include one or more buffers for buffering transmissions between one or more external devices, internal devices, the computing device 602, or the processor 604. The I/O interface 614 may couple the computing device 602 to various input devices, including touch screens, scanners, biometric readers, electronic digitizers, receivers, touchpads, cameras, keyboards, any other pointing devices, or any combinations thereof. The I/O interface 614 may couple the computing device 602 to various output devices, including printers, projectors, tactile feedback devices, automation control, robotic components, actuators, transmitters, signal emitters, lights, and so forth.

The computing system 600 may further include a storage unit 616, a network interface 618, an input controller 620, and an output controller 622. The storage unit 616, the network interface 618, the input controller 620, and the output controller 622 are communicatively coupled to the central control unit (e.g., the memory 606, the address bus 608, the control bus 610, and the data bus 612) via the I/O interface 614. The network interface 618 communicatively couples the computing system 600 to one or more networks such as wide area networks (WAN), local area networks (LAN), intranets, the Internet, wireless access networks, wired networks, mobile networks, telephone networks, optical networks, or combinations thereof. The network interface 618 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 616 is a computer-readable medium, preferably a non-transitory computer-readable medium, comprising one or more programs, the one or more programs comprising instructions which when executed by the processor 604 cause the computing system 600 to perform the method steps of the present disclosure. Alternatively, the storage unit 616 is a transitory computer-readable medium. The storage unit 616 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 616 stores one or more operating systems, application programs, program modules, data, or any other information. The storage unit 616 is part of the computing device 602. Alternatively, the storage unit 616 is part of one or more other computing machines that are in communication with the computing device 602, such as servers, database servers, cloud storage, network attached storage, and so forth.

The input controller 620 may include suitable logic, circuitry, interfaces, and/or code, executable by the circuitry, that may be configured to control one or more input devices that may be configured to receive input songs and user inputs. The output controller 622 may include suitable logic, circuitry, interfaces, and/or code, executable by the circuitry, that may be configured to control one or more output devices that may be configured to output audio tracks.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods of the generative filling of musical instrument tones to songs. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

Moreover, for example, the present technology/system may achieve the following configurations:
1. A system, comprising:
   processing circuitry that is configured to:
      determine, for a vocal track, at least one of a genre and a set of musical instruments to be added to the vocal track;
      generate, in conformity with the genre, an audio tone for each musical instrument of the set of musical instruments;
      obtain a refined temporal sequence for the audio tone based on one or more temporal dependencies associated with the audio tone;
      generate an audio waveform using the refined temporal sequence; and
      generate, based on the vocal track and the audio waveform generated for each musical instrument of the set of musical instruments, an audio track.
2. The system of 1, wherein the processing circuitry generates the audio tone for each musical instrument of the set of musical instruments in conformity with the genre using an audio synthesis model.
3. The system of 2, wherein the audio synthesis model corresponds to a combination of WaveNet and Generative Adversarial Network (GAN).
4. The system of 2,
   wherein the audio synthesis model is trained using an audio dataset including a plurality of audio tracks, and
   wherein the training of the audio synthesis model includes:
      extraction of a set of audio features for each audio track of the plurality of audio tracks;
      segmentation of each audio track into one or more musical instrument tracks based on the corresponding set of audio features;
      identification of one or more instrument tones for the one or more musical instrument tracks, respectively;
      determination of a reference genre and one or more musical instruments of each audio track based on the set of audio features, the one or more musical instrument tracks, and the one or more instrument tones; and
      generation of one or more audio tones for the one or more musical instruments, respectively, in conformity with the reference genre based on the identified one or more instrument tones using the audio synthesis model, with the audio synthesis model being iteratively trained based on the one or more instrument tones identified for each remaining audio track of the plurality of audio tracks.
5. The system of 1, wherein the processing circuitry is further configured to:
   generate, for each musical instrument of the set of musical instruments, a spectrogram that is a time-frequency representation of the audio tone generated for the corresponding musical instrument; and
   process the spectrogram based on the one or more temporal dependencies to obtain the refined temporal sequence for the audio tone.
6. The system of 5, wherein the audio tone generated for each musical instrument of the set of musical instruments is a time-domain signal, and wherein the processing circuitry generates the spectrogram based on a Short-Time Fourier Transform (STFT) operation on the audio tone.
7. The system of 6, wherein to generate the spectrogram, the processing circuitry is further configured to:
   execute the STFT operation on the audio tone to generate a complex spectrogram that includes amplitude information and phase information;
   extract an amplitude spectrogram from the complex spectrogram based on the amplitude information; and
   transform the amplitude spectrogram into a time-frequency domain.
8. The system of 1, wherein the processing circuitry generates the audio waveform by executing an Inverse Short-Time Fourier Transform (ISTFT) operation on the refined temporal sequence, and wherein the audio waveform is a time-domain audio signal.
9. The system of 1, wherein the processing circuitry obtains the refined temporal sequence using a bidirectional sequence model.
10. The system of 9, wherein the bidirectional sequence model corresponds to a Bidirectional Long Short-Term Memory (Bi-LSTM) model.
11. The system of 1, wherein to generate the audio track, the processing circuitry is further configured to execute a Simple Additive Mixing (SMA) operation on the vocal track and the audio waveform generated for each musical instrument of the set of musical instruments.
12. The system of 1, wherein the processing circuitry is further configured to receive an input song and a user input defining the genre and the set of musical instruments to be added to the vocal track.
13. The system of 12, wherein the processing circuitry is further configured to:
process the input song to determine the vocal track and at least one musical instrument tone present in the input song, and separate the vocal track and the at least one musical instrument tone.
14. The system of 13, wherein the at least one musical instrument tone is one of (i) retained in the audio track or (ii) absent in the audio track.
15. The system of 12,
wherein the user input further defines a time interval within the input song where the set of musical instruments is to be added, and
wherein the processing circuitry generates the audio track such that the audio waveform of each of the set of musical instruments is added to the vocal track in synchronization with the defined time interval.
16. A system, comprising:
   processing circuitry configured to:
      extract, from an audio dataset comprising a plurality of audio tracks, a first set of audio features for each audio track of the plurality of audio tracks;
      segment each audio track into one or more musical instrument tracks based on the corresponding first set of audio features;
      identify one or more instrument tones for the one or more musical instrument tracks, respectively;
      determine a genre and one or more musical instruments of each audio track based on the first set of audio features, the one or more musical instrument tracks, and the one or more instrument tones; and
      generate, using an audio synthesis model, one or more audio tones for the one or more musical instruments, respectively, in conformity with the genre based on the identified one or more instrument tones, wherein the audio synthesis model is iteratively trained based on the one or more instrument tones identified for each remaining audio track of the plurality of audio tracks, and wherein the trained audio synthesis model facilitates musical instrument tone synthesis for a vocal track.
17. The system of 16,
   wherein the audio dataset further comprises metadata associated with each audio track of the plurality of audio tracks, the metadata including at least one of the genre, a title, artist information, an album, release information, a duration, a time stamp, producer information, and a set of musical instruments included in the corresponding audio track, and
   wherein the audio synthesis model is trained further based on the metadata associated with each audio track of the plurality of audio tracks.
18. The system of 16, wherein the first set of audio features comprises at least one of rhythm, pitch, beat, and tone of each audio track of the plurality of audio tracks.
19. The system of 16,
   wherein the processing circuitry is further configured to extract a second set of features for each audio track of the plurality of audio tracks,
   wherein the second set of features comprises at least one of Mel-Frequency Cepstral Coefficients (MFCC), rhythmic patterns, pitch contours, harmonic structures, spectral centroid, and spectral bandwidth, and
   wherein the one or more instrument tones for the one or more musical instrument tracks, respectively, are identified based on the second set of features.
20. The system of 16, wherein the processing circuitry identifies the one or more instrument tones for the one or more musical instrument tracks, respectively, using a Support Vector Machine (SVM) classifier model.
21. The system of 16, wherein the processing circuitry is further configured to validate compatibility between the genre and each of the one or more musical instruments, and wherein an audio tone, of the one or more audio tones, for each of the one or more musical instruments is generated based on the successful validation of the compatibility between the genre and the corresponding musical instrument.
22. The system of 16, wherein the audio synthesis model corresponds to a combination of WaveNet and Generative Adversarial Network (GAN).
23. A method, comprising:
   determining, by processing circuitry, for a vocal track, at least one of a genre and a set of musical instruments to be added to the vocal track;
   generating, by the processing circuitry, in conformity with the genre, an audio tone for each musical instrument of the set of musical instruments;
   obtaining, by the processing circuitry, a refined temporal sequence for the audio tone based on one or more temporal dependencies associated with the audio tone;
   generating, by the processing circuitry, an audio waveform using the refined temporal sequence; and
   generating, by the processing circuitry, based on the vocal track and the audio waveform generated for each musical instrument of the set of musical instruments, an audio track.

What is claimed is:

1. A system, comprising:
processing circuitry that is configured to:
determine, for a vocal track, at least one of a genre and a set of musical instruments to be added to the vocal track;
generate, in conformity with the genre, an audio tone for each musical instrument of the set of musical instruments;
obtain a refined temporal sequence for the audio tone based on one or more temporal dependencies associated with the audio tone;
generate an audio waveform using the refined temporal sequence; and
generate, based on the vocal track and the audio waveform generated for each musical instrument of the set of musical instruments, an audio track.

2. The system of claim 1, wherein the processing circuitry generates the audio tone for each musical instrument of the set of musical instruments in conformity with the genre using an audio synthesis model.

3. The system of claim 2, wherein the audio synthesis model corresponds to a combination of WaveNet and Generative Adversarial Network (GAN).

4. The system of claim 2,
wherein the audio synthesis model is trained using an audio dataset including a plurality of audio tracks, and
wherein the training of the audio synthesis model includes:
extraction of a set of audio features for each audio track of the plurality of audio tracks;
segmentation of each audio track into one or more musical instrument tracks based on the corresponding set of audio features;
identification of one or more instrument tones for the one or more musical instrument tracks, respectively;
determination of a reference genre and one or more musical instruments of each audio track based on the set of audio features, the one or more musical instrument tracks, and the one or more instrument tones; and
generation of one or more audio tones for the one or more musical instruments, respectively, in conformity with the reference genre based on the identified one or more instrument tones using the audio synthesis model, with the audio synthesis model being iteratively trained based on the one or more instrument tones identified for each remaining audio track of the plurality of audio tracks.

5. The system of claim 1, wherein the processing circuitry is further configured to:
generate, for each musical instrument of the set of musical instruments, a spectrogram that is a time-frequency representation of the audio tone generated for the corresponding musical instrument; and
process the spectrogram based on the one or more temporal dependencies to obtain the refined temporal sequence for the audio tone.

6. The system of claim 5, wherein the audio tone generated for each musical instrument of the set of musical instruments is a time-domain signal, and wherein the processing circuitry generates the spectrogram based on a Short-Time Fourier Transform (STFT) operation on the audio tone.

7. The system of claim 6, wherein to generate the spectrogram, the processing circuitry is further configured to:
execute the STFT operation on the audio tone to generate a complex spectrogram that includes amplitude information and phase information;
extract an amplitude spectrogram from the complex spectrogram based on the amplitude information; and
transform the amplitude spectrogram into a time-frequency domain.

8. The system of claim 1, wherein the processing circuitry generates the audio waveform by executing an Inverse Short-Time Fourier Transform (ISTFT) operation on the refined temporal sequence, and wherein the audio waveform is a time-domain audio signal.

9. The system of claim 1, wherein the processing circuitry obtains the refined temporal sequence using a bidirectional sequence model.

10. The system of claim 9, wherein the bidirectional sequence model corresponds to a Bidirectional Long Short-Term Memory (Bi-LSTM) model.

11. The system of claim 1, wherein to generate the audio track, the processing circuitry is further configured to execute a Simple Additive Mixing (SMA) operation on the vocal track and the audio waveform generated for each musical instrument of the set of musical instruments.

12. The system of claim 1, wherein the processing circuitry is further configured to receive an input song and a user input defining the genre and the set of musical instruments to be added to the vocal track.

13. The system of claim 12, wherein the processing circuitry is further configured to:
process the input song to determine the vocal track and at least one musical instrument tone present in the input song, and separate the vocal track and the at least one musical instrument tone.

14. The system of claim 13, wherein the at least one musical instrument tone is one of (i) retained in the audio track or (ii) absent in the audio track.

15. A system, comprising:
processing circuitry configured to:
extract, from an audio dataset comprising a plurality of audio tracks, a first set of audio features for each audio track of the plurality of audio tracks;
segment each audio track into one or more musical instrument tracks based on the corresponding first set of audio features;
identify one or more instrument tones for the one or more musical instrument tracks, respectively;
determine a genre and one or more musical instruments of each audio track based on the first set of audio features, the one or more musical instrument tracks, and the one or more instrument tones; and
generate, using an audio synthesis model, one or more audio tones for the one or more musical instruments, respectively, in conformity with the genre based on the identified one or more instrument tones, wherein the audio synthesis model is iteratively trained based on the one or more instrument tones identified for each remaining audio track of the plurality of audio tracks, and wherein the trained audio synthesis model facilitates musical instrument tone synthesis for a vocal track.

16. The system of claim 15,
wherein the audio dataset further comprises metadata associated with each audio track of the plurality of audio tracks, the metadata including at least one of the genre, a title, artist information, an album, release information, a duration, a time stamp, producer information, and a set of musical instruments included in the corresponding audio track, and
wherein the audio synthesis model is trained further based on the metadata associated with each audio track of the plurality of audio tracks.

17. The system of claim 15,
wherein the processing circuitry is further configured to extract a second set of features for each audio track of the plurality of audio tracks,
wherein the second set of features comprises at least one of Mel-Frequency Cepstral Coefficients (MFCC), rhythmic patterns, pitch contours, harmonic structures, spectral centroid, and spectral bandwidth, and
wherein the one or more instrument tones for the one or more musical instrument tracks, respectively, are identified based on the second set of features.

18. The system of claim 15, wherein the processing circuitry is further configured to validate compatibility between the genre and each of the one or more musical instruments, and wherein an audio tone, of the one or more audio tones, for each of the one or more musical instruments is generated based on the successful validation of the compatibility between the genre and the corresponding musical instrument.

19. The system of claim 15, wherein the audio synthesis model corresponds to a combination of WaveNet and Generative Adversarial Network (GAN).

20. A method, comprising:
determining, by processing circuitry, for a vocal track, at least one of a genre and a set of musical instruments to be added to the vocal track;
generating, by the processing circuitry, in conformity with the genre, an audio tone for each musical instrument of the set of musical instruments;
obtaining, by the processing circuitry, a refined temporal sequence for the audio tone based on one or more temporal dependencies associated with the audio tone;
generating, by the processing circuitry, an audio waveform using the refined temporal sequence; and
generating, by the processing circuitry, based on the vocal track and the audio waveform generated for each musical instrument of the set of musical instruments, an audio track.
